(19) United States
(12) Patent Application Publication
(10) Pub. No.: US 2015/0370856 A1
(43) Pub. Date: Dec. 24, 2015

(54) METHOD AND SYSTEM FOR PROCESSING A SEARCH QUERY

(71) Applicants: SONY CORPORATION, Tokyo (JP); SONY NETWORK ENTERTAINMENT INTERNATIONAL LLC, Los Angeles, CA (US)

(72) Inventor: Brian Johnson, San Francisco, CA (US)

(21) Appl. No.: 14/307,717

(22) Filed: Jun. 18, 2014

(51) Int. Cl. G06F 17/30

(52) U.S. Cl. CPC G06F 17/30477; G06F 17/30589

(57) ABSTRACT

Various aspects of a method and a system for processing a search query are disclosed herein. The method includes receiving a search query from a user. Based on the received search query, a set of search results is determined. The set of search results includes a set of first-level search results and a set of second-level search results, which are hierarchically, associated with each search result of the sets of first-level search results. Further, the at least one search result of second-level search results is modified to comprise that portion of text of the at least one search result of set of second-level search results, which differ from one or more portions of the text of the associated set of first-level search results.

### FIELD

Various embodiments of the disclosure relate to processing a search query. More specifically, various embodiments of the disclosure relate to processing a search query to provide results in a hierarchal structure.

### BACKGROUND

Recent advancements in technology have made it possible for a user to employ various searching methodologies to obtain desired content from high-volume databases. In general, searching methodologies may provide unstructured search results based on a search query provided by the user. In certain scenarios, it may be difficult for the user to identify and correlate such unstructured search results owing to high volume of data.

Further limitations and disadvantages of conventional and traditional approaches will become apparent to one of skill in the art, through comparison of described systems with some aspects of the present disclosure as set forth in the remainder of the present application with reference to the drawings.

### SUMMARY

A method and a system are provided for processing a search query substantially as shown in, and/or described in connection with, at least one of the figures, as set forth more completely in the claims.

These and other features and advantages of the present disclosure may be appreciated from a review of the following detailed description of the present disclosure, along with the accompanying figures, in which like reference numerals refer to like parts throughout.

### BRIEF DESCRIPTION OF THE DRAWINGS

FIG. 1 is a block diagram illustrating a network environment for processing a search query, in accordance with an embodiment of the disclosure.

FIG. 2 is a block diagram illustrating an electronic device, in accordance with an embodiment of the disclosure.

FIG. 3 is a block diagram illustrating a gaming server, in accordance with an embodiment of the disclosure.

FIG. 4 illustrates an exemplary interface of an exemplary electronic device, in accordance with an embodiment of the disclosure.

FIG. 5 is a flow chart illustrating a method for processing a search query, in accordance with an embodiment of the disclosure.

### DETAILED DESCRIPTION

The following described implementations may be found in a method and a system for processing a search query. Exemplary aspects of the disclosure may comprise a method for receiving a search query from a user. In an embodiment, the search query may comprise a sequence of alphanumeric characters. The method may further comprise determining a set of search results based on the received search query. The set of search results may comprise a set of first-level search results and a set of second-level search results that are associated with each search result of the set of first-level search results. Further, the one or more search results of the set of second-level search results may be modified to comprise a portion of text which are different from one or more portions of text of the associated set of first-level search results. The method may further comprise determining the set of first-level search results and the set of second-level search results that comprise the sequence of alphanumeric characters. The method may further comprise determining a set of first-level search results, which correspond to a set of second-level search results that does not comprise the sequence of alphanumeric characters.

In an embodiment, the set of first-level results may be displayed. The set of first-level search results may be arranged in an alphabetical order or a reverse alphabetical order. Each search result of the set of second-level search results may be displayed hierarchically as being structured under the set of first-level search results. The hierarchal structure may be based on an association between content of each search result of the set of first-level search results and content of each search result of the set of second-level search results. In an embodiment, the set of second-level search results, hierarchically structured under each search result of the set of first-level search results, are arranged in the alphabetical order.

In an embodiment, the set of first-level results may correspond to a title of a gaming application. Further, each search result of the set of second-level search results may correspond to one or more of a title of an add-on, a theme, an avatar, and/or a wall paper associated with each search result of the set of first-level search results. In an embodiment, only the set of first-level search results may be displayed. In another embodiment, both the set of first-level search results and the set of second-level search results may be displayed.

In an embodiment, a user may select a sequence of alphanumeric characters from a list of alphanumeric characters displayed on a user interface. In an embodiment, the list of alphanumeric characters may be dynamically updated based on the sequence of alphanumeric characters selected by the user. In an embodiment, the set of search results may be dynamically updated based on the sequence of alphanumeric characters selected by the user.

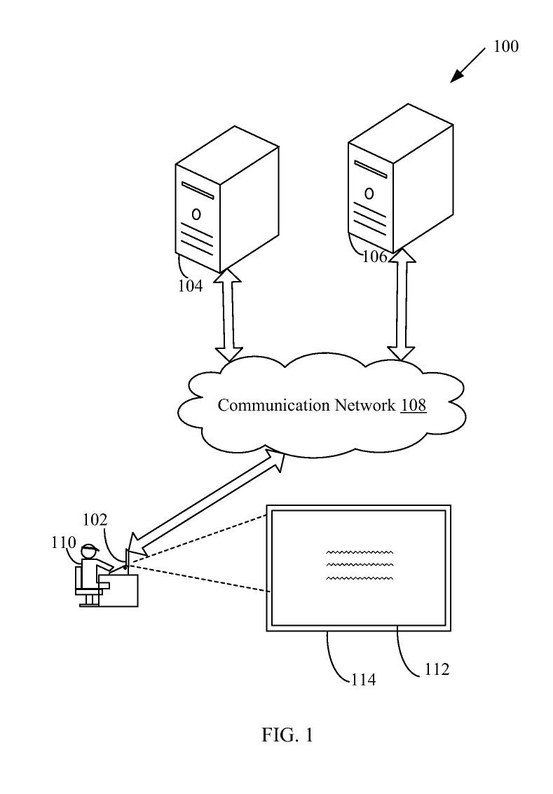

FIG. 1 is a block diagram illustrating a network environment, in accordance with an embodiment of the disclosure. With reference to FIG. 1, there is shown a network environment 100. The network environment 100 may comprise an electronic device 102, an online application server 104, a gaming server 106, a communication network 108, a user 110, a user interface 112 and a display screen 114.

The electronic device 102 may be communicatively coupled with the online application server 104 and the gaming server 106 through the communication network 108. The electronic device 102 may be associated with the user 110. The user 110 may interact with the electronic device 102 via the user interface 112 shown on the display screen 114.

The electronic device 102 may comprise suitable logic, circuitry, interfaces, and/or code that may be operable to receive an input, such as a search query, from the user 110 and render an output based on the received input. Examples of the electronic device 102 may include, but are not limited to, gaming consoles, laptops, tablet computers, smartphones, and/or Personal Digital Assistant (PDA) devices. Although FIG. 1 shows only the electronic device 102 associated with the user 110 for simplicity, one skilled in the art may appreciate that the disclosed embodiments may be implemented for a larger number of electronic devices and associated users in the network environment 100 and remain in the scope of the disclosure.

The online application server 104 may comprise suitable logic, circuitry, interfaces, and/or code that may be operable to host web-based applications for the user 110. Examples of the web-based applications may include, but are not limited to, multi-player games, online search providers, online movie repositories and/or the like. Such web-based applications may be reliant on a common web browser to execute the online application hosted by the online application server 104.

In an embodiment, the online application server 104 may be operable to host and stream single-player or multi-player gaming applications. Examples of such online gaming applications may include, but are not limited to, a console-based game, a browser-based game, a cloud-based game, a mobile-based game, and/or a tablet-based game. Such a gaming application may be reliant on a common web browser, such as the user interface 112 rendered on the display screen 114 of the electronic device 102. It will be appreciated by those skilled in the art that any localized (hereafter, referred to as offline) or centralized (hereafter, referred to as online) gaming application may be executed on the electronic device 102 without deviating from the scope of the disclosure. Examples of the online application server 104 may include, but are not limited to, Sun Java Application server®, Weblogic server®, Apache Geronimo®, Bea Weblogic®, and/or IBM WebSphere®.

The gaming server 106 may comprise suitable logic, circuitry, interfaces, and/or code that may be operable to host at least one of a plurality of gaming applications, such as Fight Night®, Uncharted®, Red Dead Redemption®, Injustice®, Midnight Club®, and/or the like.

The communication network 108 may comprise a medium through which the electronic device 102 may communicate with the online application server 104, and the gaming server 106. Examples of the communication network 108 may include, but are not limited to, the Internet, a Wireless Fidelity (Wi-Fi) network, a Wireless Local Area Network (WLAN), a Local Area Network (LAN), a telephone line (POTS), and/or a Metropolitan Area Network (MAN). The electronic device 102, the online application server 104, and the gaming server 106 in the network environment 100 may be operable to communicate via the communication network 108. The communication may be in accordance with various wired and wireless communication protocols, such as, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

The user interface 112 may be a graphical user interface (GUI) that may be rendered on the display screen 114 of the electronic device 102. The user interface 112 may enable the user 110 to access, retrieve, view, and/or execute applications hosted by a plurality of application servers, such as the online application server 104 and the gaming server 106. In an embodiment, the user interface 112 may further enable the user 110 to access, retrieve, view, and/or execute offline applications stored in a local memory of the electronic device 102. In an embodiment, the user 110 may install a software application (not shown) on the electronic device 102, to present the user interface 112.

In operation, a search query may be received from the user 110 through the user interface 112. The search query may comprise a sequence of alphanumeric characters, which may correspond to any language, such as English, German, Hindi, and/or the like. Based on the search query provided by the user 110, the electronic device 102 may be operable to determine a set of search results. The set of search results may comprise a set of first-level search results and a set of second-level search results.

In an embodiment, the set of second-level search results may be hierarchically structured under the set of first-level search results. Such a hierarchical structure may be based on an association between content of each search result of the set of first-level search results and content of each search result of the set of second-level search results.

The electronic device 102 may be operable to determine a common portion of text between at least one search result from the set of second-level search results and an associated search result from the set of first-level search results. The electronic device 102 may be further operable to modify the at least one search result from the set of second-level search results. In an embodiment, the at least one search result from the set of second-level search results may be modified to delete the determined common portion of text. In an embodiment, the common portion of text may correspond to at least one word in the title of at least one search result from the set of search results.

In an embodiment, the user interface 112 may display the at least one search result from the set of second-level search results hierarchically structured under the associated search result from the set of first-level search results. In another embodiment, the user interface 112 may display the at least one modified second-level search result hierarchically structured under the associated first-level search results from the set of first-level search results.

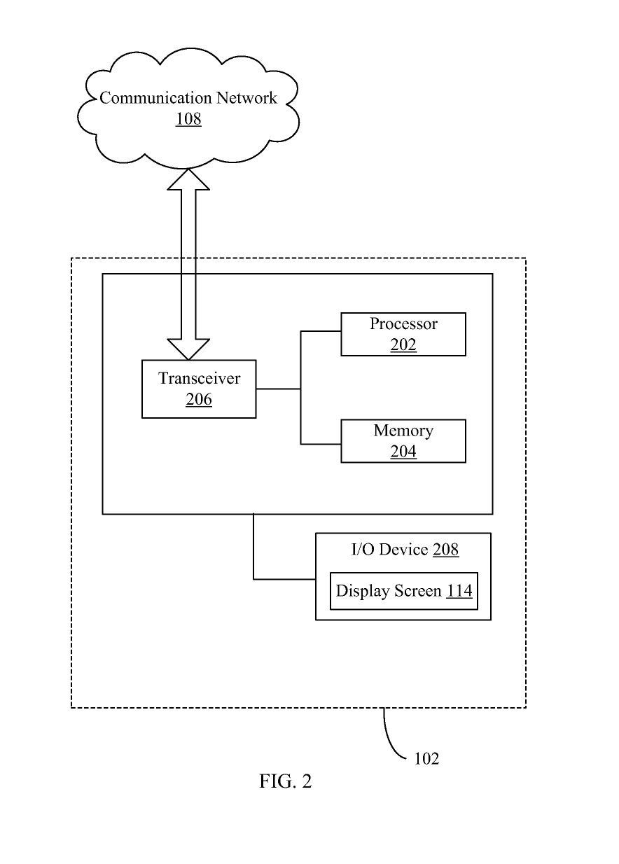

FIG. 2 is a block diagram illustrating an electronic device, in accordance with an embodiment of the disclosure. FIG. 2 is explained in conjunction with elements from FIG. 1. With reference to FIG. 2, there is shown the electronic device 102. The electronic device 102 may comprise one or more processors, such as a processor 202, a memory 204, a transceiver 206, and one or more Input-Output (I/O) devices, such as an I/O device 208. The processor 202 may be communicatively coupled to the memory 204, and the I/O device 208. Further, the transceiver 206 may be communicatively coupled to the processor 202, the memory 204, and the I/O device 208. Further, the transceiver 206 may be communicatively coupled with the online application server 104 and the gaming server 106 via the communication network 108.

The processor 202 may comprise suitable logic, circuitry, interfaces, and/or code that may be operable to execute a set of instructions stored in the memory 204. The processor 202 may be implemented based on a number of processor technologies known in the art. Examples of processor 202 may be an X86-based processor, a Reduced Instruction Set Computing (RISC) processor, an Application-Specific Integrated Circuit (ASIC) processor, a Complex Instruction Set Computing (CISC) processor, or any other processor.

The memory 204 may comprise suitable logic, circuitry, interfaces, and/or code that may be operable to store the received set of instructions. The memory 204 may be further operable to store a repository associated with the plurality of gaming applications. The repository may include content, such as title name and themes, associated with the plurality of gaming applications. The memory 204 may be further operable to store metadata, such as a genre, associated with the plurality of gaming applications. The memory 204 may be implemented based on, but not limited to, a Random Access Memory (RAM), a Read-Only Memory (ROM), a Hard Disk Drive (HDD), a storage server and/or a Secure Digital (SD) card.

The transceiver 206 may comprise suitable logic, circuitry, interfaces, and/or code that may be operable to communicate with the online application server 104, and the gaming server 106, via various communication interfaces. The transceiver 206 may implement known technologies for supporting wired or wireless communication with the communication network 108. The transceiver 206 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a wireless local area network (LAN) and/or a metropolitan area network (MAN), and other devices. The wireless communication may use any of a plurality of communication standards, protocols and technologies including, but not limited to, Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The I/O device 208 may comprise various input and output devices that may be operable to connect to the processor 202. Examples of the input devices may include, but are not limited to, a keyboard, a mouse, a joystick, a touch screen, a microphone, a camera, a motion sensor, a light sensor, and/or a docking station. Examples of the output devices may include, but are not limited to, the display screen 114, and/or a speaker.

In operation, the processor 202 of the electronic device 102 may be operable to receive the search query from the user 110. The search query may comprise a sequence of alphanumeric characters, which may be selected by the user 110 from a list of characters. The list of characters may be displayed on the user interface 112. In an embodiment, the list of characters may be scrolled through and a character may be selected using an I/O device 208, such as a pointing device.

In an embodiment, the sequence of alphanumeric characters may be selected by the user 110 one character at a time. Every time a character is selected, the processor 202 may be operable to dynamically update the displayed list of characters.

In another embodiment, every time a character is selected from the list of characters, the processor 202 may be operable to suggest one or more words to the user 110. The one or more words may be suggested based on a prediction algorithm stored in the memory 204. The user 110 may then select a desired word as a part of the search query.

The processor 202 may be operable to determine the set of search results based on the search query received from the user 110. In an embodiment, the set of search results may comprise the set of first-level search results and the set of second-level search results. In an embodiment, based on the received search query, the processor 202 may be operable to retrieve content associated with a gaming application stored in the memory 204. In another embodiment, the content associated with the gaming application may be stored on the gaming server 106. The content associated with the gaming application may further comprise a first type of associated content and a second type of associated content.

In an embodiment, the first type of associated content may correspond to an executable file of the gaming application. The second type of associated content may correspond to a software upgrade, an add-on, an avatar, a theme and/or a wall-paper related to the gaming application. In such an embodiment, the processor 202 may be operable to determine the set of first-level search results based on the first type of associated content. The processor 202 may be operable to determine the set of second-level search results based on the second type of associated content.

For example, for a gaming application entitled, “Red Dead Redemption”, the first type of associated content may comprise the gaming application, “Red Dead Redemption”. The second type of associated content may include the add-on, “Red Dead Redemption Undead Nightmare Pack” and the theme, “Red Dead Redemption Undead Nightmare Theme”.

In another embodiment, the processor 202 may be operable to retrieve metadata associated with the gaming application. Based on the metadata, the processor 202 may be operable to categorize the set of search results and display on the user interface 112. In an embodiment, the user 110 may select one or more options displayed on the user interface 112. The one or more options may correspond to metadata, such as genre and developer, stored in the memory 204.

In an embodiment, the processor 202 may be operable to determine the set of second-level search results, such that each search result of the set of second-level search results comprise the sequence of alphanumeric characters selected by the user 110.

In an embodiment, the processor 202 may be operable to determine a common portion of text between at least one search result from the set of second-level search results and the associated first-level search result. In such an embodiment, the processor 202 may be operable to modify the at least one search result from the set of second-level search results. The at least one search result from the set of second-level search result may be modified to delete the common portion of text.

For example, the user 110 may select a sequence of alphanumeric characters, “Nigh”, as search query from the list of characters displayed on the user interface 112. Based on the search query, “Nigh”, the processor 202 may determine the set of first-level search results based on the first-type of associated content. The first-type of associated content may correspond to the gaming application, such as the gaming application, “Red Dead Redemption”. Based on the search query, “Nigh”, the processor 202 may further determine the set of second-level search results that comprises the sequence of alphanumeric characters, “Nigh”. The processor 202 may retrieve, “Red Dead Redemption Undead Nightmare Pack”, and, “Red Dead Redemption Undead Nightmare Theme”, as the set of second-level search results. The set of second-level search results may be based on the second type of associated content of the gaming application, “Red Dead Redemption”.

Further, the processor 202 may be operable to determine the common portion of text between at least one search result from the set of second-level search results and the associated first-level search result from the set of first-level search results. In this example, “Red Dead Redemption”, is determined to be the common portion of text between the two second-level search results and the associated first-level search result. The processor 202 may modify the two second level results by deletion of the common portion, “Red Dead Redemption”. Hence the modified set of second results will be, “Undead Nightmare Pack” and, “Undead Nightmare Theme”.

In an embodiment, the processor 202 may be operable to determine the set of first-level search results, such that at least one search result of the set of first-level search results may comprise the sequence of alphanumeric characters. In such a case, the processor 202 may not determine the set of second-level results if the associated set of second-level results does not comprise the sequence of alphanumeric characters. The processor 202 may be operable to display the determined set of search results on the display screen 114 through the user interface 112.

In an embodiment, the set of first-level search results and the set of second-level search results may be displayed in a hierarchal structure. In an embodiment, the set of first-level search results may be displayed as one or more parent nodes in the hierarchal structure. The one or more second-level search results may be displayed as one or more child nodes associated with respective one or more parent nodes in the hierarchal structure. In an embodiment, the hierarchical structure may be displayed in one of a vertical format or a horizontal format. In an embodiment, both the set of first-level search results and the set of second-level search results may be sorted alphabetically or reverse-alphabetically to be rendered on the user interface 112.

In another embodiment, the set of results may be categorized based on the metadata associated with each of the plurality of gaming applications stored in the memory 204. In such an embodiment, the user 110 may enter the search query, “Nigh”, and may select a type of the metadata, such as genre, to categorize the set of results. In such an embodiment, the set of results may be displayed based on the genre of the set of search results.

In an embodiment, the transceiver 206 may be operable to transmit the search query to the online application server 104. The transceiver 206 may further be operable to receive the set of search results from the online application server 104, to be rendered on the display screen 114, via the user interface 112. In an embodiment, the transceiver 206 may be operable to transmit the search query to the gaming server 106. The transceiver 206 may further be operable to receive the set of search results from the gaming server 106, to be rendered on the display screen 114, via the user interface 112.

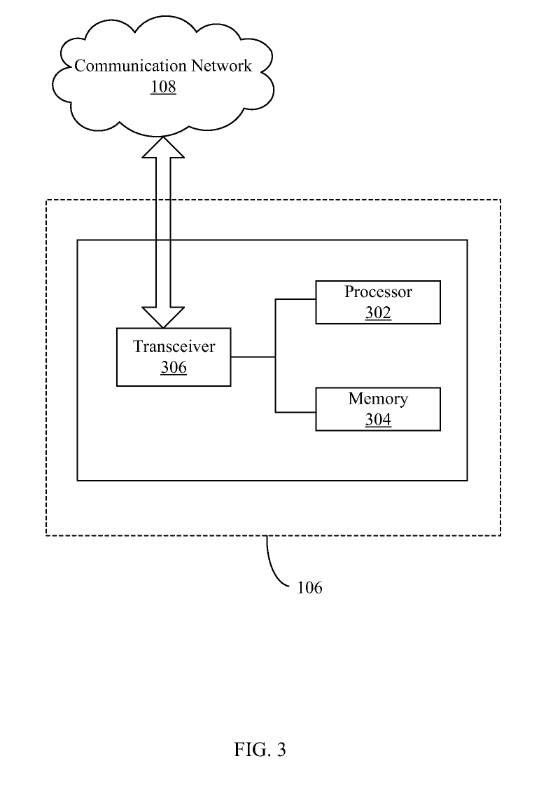

FIG. 3 is a block diagram illustrating a gaming server, in accordance with an embodiment of the disclosure. FIG. 3 is explained in conjunction with elements from FIG. 1. With reference to FIG. 3, there is shown the gaming server 106. The gaming server 106 may include one or more processors, such as a processor 302, a memory 304, and a transceiver 306.

The processor 302 may be communicatively coupled to the memory 304, and the transceiver 306. Further, the transceiver 306 may be communicatively coupled to the processor 302 and the memory 304. The processor 302, the memory 304, and the transceiver 306 may be similar in functionality and examples to the processor 202, the memory 204, and the transceiver 206 described with reference to FIG. 2.

The memory 304 may comprise suitable logic, circuitry, interfaces, and/or code that may be operable to store the received set of instructions. The memory 204 may be further operable to store a repository associated with the plurality of gaming applications. The memory 304 may be further operable to store metadata, such as a genre, a developer, and/or one or more characters, associated with the plurality of gaming applications.

The transceiver 306 may comprise suitable logic, circuitry, interfaces, and/or code that may be operable to communicate with the electronic device 102 and the online application server 104, via different communication interfaces. The transceiver 306 may implement known technologies for supporting wired or wireless communication with the communication network 108.

In operation, the transceiver 306 may be operable to receive the search query from the electronic device 102. Based on the received search query, the processor 302 may be operable to determine the set of search results. The received search query may comprise a sequence of alphanumeric characters. The set of search results may comprise the set of first-level search results and the set of second-level search results.

In an embodiment, the processor 302 may be operable to determine the set of first-level search results based on the first type of associated content stored in memory 304. The first type of associated content may correspond to the gaming application selected by the processor 302 based on the received search query.

The processor 302 may be further operable to determine the set of second-level search results, such that each search result of the set of second-level search results comprises the sequence of alphanumeric characters in the search query. In an embodiment, the processor 302 may be operable to determine the set of second-level search results based on the second type of associated content stored in the memory 304 and on the received search query. The second type of associated content may correspond to the software upgrade, the add-on, the avatar, the theme and/or a wall-paper associated with the gaming application. In such an embodiment, the processor 302 may be operable to transmit the determined set of first-level and second-level search results to the electronic device 102 via the transceiver 306. In an embodiment, the processor 302 may be operable to determine the common portion of text between the at least one search result from the set of second-level search results and the associated search result from the set of first-level search results.

In such an embodiment, the processor 302 may be operable to modify the at least one search result from the set of second-level search results. In accordance with such a modification, the processor 302 may be operable to delete the common portion of text between the at least one search result from the set of second-level search result and the associated first-level search result. In such an embodiment, the processor 302 may be operable to transmit the determined set of first-level search results and the at least one modified search result of the set of second-level search results to the electronic device 102, via the transceiver 306.

In an embodiment, the processor 302 may be operable to determine the set of first-level search results, such that each search result of the set of first-level search results comprises the sequence of alphanumeric characters. In such a case, the set of second-level results may not comprise the sequence of alphanumeric characters in the search query. In such an embodiment, the processor 302 may be operable to transmit only the determined set of first-level search results to the electronic device 102 via the transceiver 306.

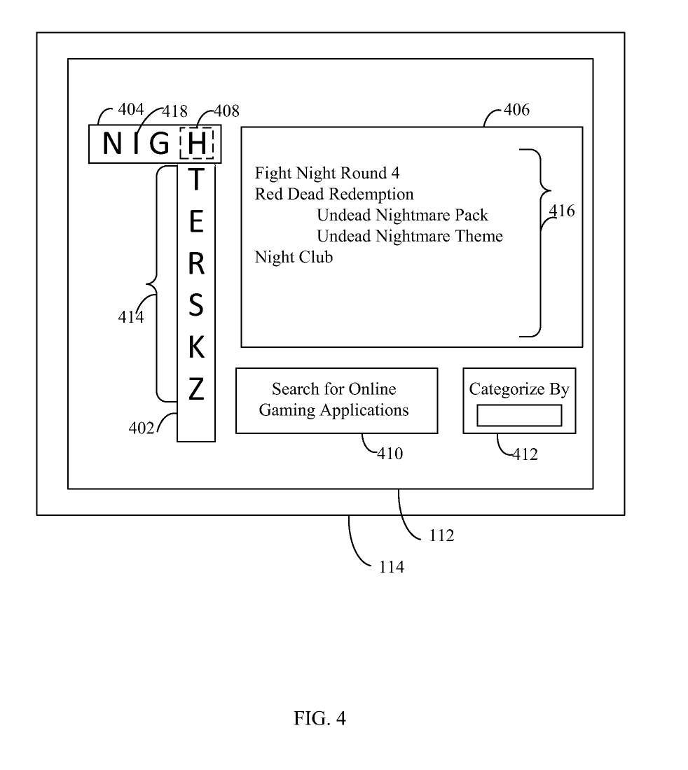

FIG. 4 illustrates an exemplary interface of an exemplary electronic device, in accordance with an embodiment of the disclosure. FIG. 4 is explained in conjunction with elements from FIG. 1, FIG. 2, and FIG. 3. With reference to FIG. 4, there is shown the display screen 114, rendering the user interface 112, which corresponds to the application for processing a search query executed at the electronic device 102. The user interface 112 may comprise a first display segment 402, a second display segment 404, a third display segment 406, and a highlighter 408. The user interface 112 may further comprise a first option, “Search for Online Gaming Applications” 410, and a second option, “Filter By” 412. The first display segment 402 may comprise a list of characters 414 selectable by the user 110. The second display segment 404 may display a search query that comprises a sequence of alphanumeric characters 418 selected by the user 110 from the list of characters 414. The third display segment 406 may display a set of search results 416 in a hierarchal structure based on the search query.

In an embodiment, the user 110 may scroll through the list of characters 414 by using the I/O device 208, such as a mouse. In an embodiment, the user 110 may use the highlighter 408 to select a sequence of alphanumeric characters from the list of characters 414 to generate a search query. In an embodiment, the user 110 may select the sequence of alphanumeric characters by scrolling the list of characters 414 such that a desired character is highlighted based on a position of the highlighter 408. The second display segment 404 may display the sequence of alphanumeric characters 418 selected by the user 110 from the list of characters 414.

In an example, the user 110 may scroll the displayed list of characters 414 to select a first character, “N”. Based on the selection of the first character, “N”, the processor 202 may dynamically update the displayed list of characters 414 to comprise a plurality of characters which may provide an indication to a preferred search query.

In the example, the user 110 may highlight a plurality of characters in a sequence in the displayed list of characters 414 based on the position of the highlighter 408. The user 110 may select the highlighted plurality of characters in the sequence selected to generate the sequence of alphanumeric characters 418, such as, “I”, “G” and “H”, the sequence of alphanumeric characters. Thus, based on the selected sequence of alphanumeric characters 418, a search query, “NIGH”, is displayed on the second display segment 404.

Based on the sequence of alphanumeric characters 418, the processor 202 may be operable to determine the set of search results based on an associated content which comprises the sequence of alphanumeric characters 418, “NIGH”.

In an embodiment, the processor 202 may be operable to determine, “Fight Night Round 4”, as a search result from the set of the first-level search results. The search result from the set of first level results may correspond to a first type of associated content for the gaming application, entitled, “Fight Night Round 4”. The processor 202 may be further operable to determine, “Bernard Hopkins”, “Nightmare”, and, “Champions Pack II” as one or more search results from the set of the second-level search results. Such one or more search results from the set of the second-level search results may correspond to the determined search result from the set of the first-level search results. In such an embodiment, the processor 202 may be operable to display, “Fight Night Round 4”, as a parent node and, “Nightmare”, as a child node associated with the parent node in a hierarchal structure. Such a hierarchal structure may be displayed in the third display segment 406.

In an embodiment, the processor 202 may be operable to determine, “Red Dead Redemption: Undead Nightmare Pack”, and, “Red Dead Redemption: Undead Nightmare Theme”, as one or more search results from the set of the second-level search results. The processor 202 may be further operable to determine, “Red Dead Redemption”, as a search result from the set of the first-level search results. The processor 202 may further be operable to modify the one or more search results from the set of the second-level search results. The one or more search results from the set of the second-level search results may be modified based on deletion of common portion of text, “Red Dead Redemption”. In such an embodiment, the processor 202 may be operable to display, “Red Dead Redemption”, as a parent node and, “Undead Nightmare Pack”, and, “Undead Nightmare Theme”, as two child nodes associated with the parent node in a hierarchal structure. Such a hierarchal structure may be displayed in the third display segment 406.

In an embodiment, the processor 202 may be operable to determine, “Night Club”, as a search result from the set of the second-level search results. In such an embodiment, there may be no search result from the set of first-level results associated with the determined search result from the set of the second-level search results. In such an embodiment, the processor 202 may be operable to display, “Night Club”, as a parent node in a hierarchal structure with no child nodes in the third display segment 406.

The first option, “Search for Online Gaming Applications” 410, may be selected by the user 110 to search for online gaming applications. The online gaming applications may be hosted by the online application server 104, in conjunction with the gaming server 106. The second option, “Filter By” 412, may be selected by the user 110 to categorize the set of search results based on the metadata stored in the memory 204

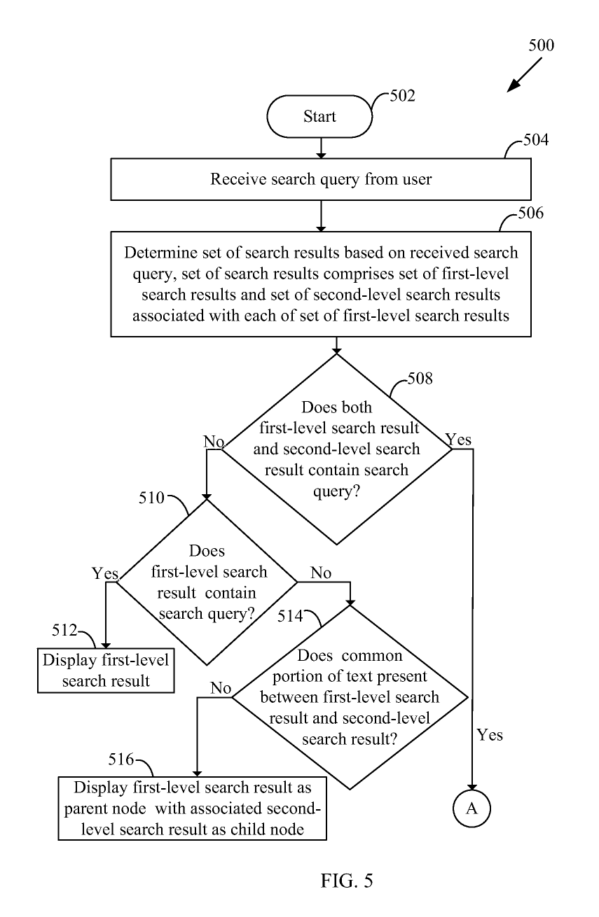

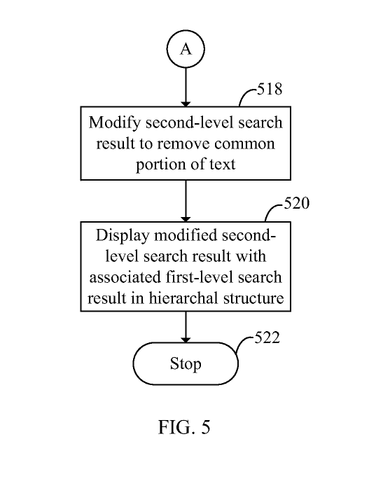

FIG. 5 is a flowchart illustrating a method for processing a search query, in accordance with an embodiment of the disclosure. FIG. 5 is described in conjunction with elements of FIG. 1 and FIG. 2. The method 500 may be implemented in the electronic device 102, communicatively coupled to the online application server 104, and the gaming server 106, via the communication network 108.

The method 500 begins at step 502 and proceeds to step 504. At step 504, the processor 202 may receive the sequence of alphanumeric characters as a search query from the user 110, via the user interface 112. Once the search query is received from the user 110, the control passes to step 506.

At step 506, the set of search results 416 may be determined, based on the received search query. The set of search results may comprise the set of first-level search results and the set of second-level search results. The set of first-level search results may be determined based on the first type of associated content stored in the memory 204. The set of second-level search results may be determined based on the second type of associated content stored in the memory 204. The set of second-level search results may be hierarchically associated with the set of second-level search results.

At step 508, it may be determined whether one or more search results from the set of first-level search results and at least one search result from the set of second-level results comprise the search query. In instances where only one of the one or more search results from the set of first-level search results and the at least one search result from the set of second-level results comprise the search query, the control proceeds to step 510.

At step 510, it may be determined whether the one or more search results from the set of first-level search result comprises the search query. In instances where the one or more search results from the set of first-level search results comprise the search query, the control proceeds to step 512. At step 512, the one or more search results from the set of first-level search results may be rendered in the user interface 112, as a parent node, and the control moves to end step 522.

In instances where the one or more search results from the set of first-level search result does not comprise the search query, the control proceeds to step 514. At step 514, a common portion of text may be determined between the at least one search result from the set of second-level search results and an associated search result from the set of first-level search results.

In instances where there is no common portion of text between the at least one search result from the set of second-level search results and an associated search result from the set of first-level search results, the control proceeds to step 516.

At step 516, the at least one search result from the set of second-level search results may be displayed as a child node in the hierarchal structure and the associated search result from the set of first-level search results may be displayed as a parent node in the hierarchal structure. Control then moves to end step 522.

In instances where there is a common portion of text between the at least one search result from the set of second-level search results and an associated search result from the set of first-level search results, the control proceeds to step 518. At step 518, the at least one search result may be modified from the set of second-level search results to delete the common portion of text.

At step 520, the modified search result from the set of second-level search results may be displayed as a child node in the hierarchal structure. The associated search result from the set of first-level search results may further be displayed as a parent node in the hierarchal structure. Control then moves to the end step 522.

In accordance with the present disclosure, a system for processing a search query is presented. Exemplary aspects of the disclosure may comprise one or more processors and/or circuits, such as the processor 202 (FIG. 2), in the electronic device 102 (FIG. 1). The processor 202 may be operable to receive a search query from a user 110 (FIG. 1). The received search query may comprise a sequence of alphanumeric characters 418. The processor 202 may be operable to determine a set of search results. The set of search results may comprise a set of first-level search results and a set of second-level search results, which are associated with each search result of the set of first-level search results, Further at least one of the second-level search results may be modified to comprise that portion of the at least one of the second-level search results, which differ from one or more portions of associated first-level search result.

In an embodiment, the processor 202 may be operable to determine the set of first-level search results and the set of second-level of search results that comprise the received sequence of alphanumeric characters 418. In an embodiment, the processor 202 may be operable to determine the set of first-level search results, which correspond to the set of second-level of search results that comprise the sequence of alphanumeric characters 418. In an embodiment, the processor 202 may be further operable to display the determined set of search results.

Various embodiments of the disclosure may provide a non-transitory computer readable medium and/or storage medium, and/or a non-transitory machine readable medium and/or storage medium having applicable mediums stored thereon, a machine code and/or a computer program having at least one code section executable by a machine and/or a computer for processing a search query. The at least one code section, may cause the machine and/or computer to perform the steps comprising in an electronic device. The machine and/or computer performs the steps comprising receiving a search query from a user. The machine and/or computer further performs the steps comprising determining a set of search results based on the received search query. The set of search results may comprise a set of first-level search results and a set of second-level search results which are associated with each search result of the set of first-level search results. Further at least one of the second-level search results may be modified to comprise that portion of the at least one of the second-level search results which is different from one or more portions of associated set of first-level search result.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for processing a search query, said method comprising:
in an electronic device:
receiving said search query from a user; and
determining a set of search results based on said received search query, wherein said set of search results comprises a set of first-level search results and a set of second-level search results associated with each search result of said set of first-level search results, wherein at least one search result from said set of second-level search results is modified to comprise a portion of text of said at least one search result from said set of second-level search results that is different from one or more portions of text of said associated said set of first-level search results.

2. The method of claim 1, wherein said search query comprises a sequence of alphanumeric characters.

3. The method of claim 2, wherein determining said set of search results comprises determining said set of first-level search results that comprise said sequence of alphanumeric characters.

4. The method of claim 2, wherein determining said set of search results comprises determining said set of second-level search results that comprise said sequence of alphanumeric characters.

5. The method of claim 2, wherein determining said set of search results comprises determining said set of first-level search results corresponding to said set of second-level search results that comprise said sequence of alphanumeric characters.

6. The method of claim 5, further comprising displaying said determined set of search results.

7. The method of claim 1, wherein said set of first-level search results are arranged in an alphabetical order or in reverse-alphabetical order.

8. The method of claim 1, wherein each of said set of second-level search results is hierarchically structured under said set of first-level search results based on an association between content of each of said set of first-level search results and content of each of said set of second-level search results.

9. The method of claim 1, wherein said set of second-level search results hierarchically structured under each of said set of first-level search results are arranged in an alphabetical order.

10. The method of claim 1, wherein each of said set of first-level search results corresponds to one of: a title of a gaming application or a title of media content.

11. The method of claim 1, wherein each of said set of second-level search results corresponds to one or more of: an add-on, a theme, an avatar, and a wall paper associated with each of said set of first-level search results.

12. The method of claim 1, further comprising displaying said set of first-level search results.

13. The method of claim 1, further comprising displaying said set of first-level search results and said set of second-level search results.

14. The method of claim 1, further comprising displaying a list of input alphanumeric characters for selection by said user.

15. The method of claim 14, further comprising dynamically updating said list of input alphanumeric characters based on said selection by said user.

16. The method of claim 14, further comprising dynamically updating said set of search results based on said selection by said user.

17. A system for processing a search query, said system comprising:
one or more processors in an electronic device, said one or more processors being operable to:
receive said search query from a user, wherein said received search query comprises a sequence of alphanumeric characters; and
determine a set of search results based on said received search query, wherein said set of search results comprises a set of first-level search results and a set of second-level search results associated with each search result of said set of first-level search results, wherein at least one search result from said set of second-level search results is modified to comprise a portion of text of said at least one search result from said set of second-level search results that is different from one or more portions of text of said associated said set of first-level search results.

18. The system of claim 17, wherein said set of search results comprises said set of first-level search results that comprise said sequence of alphanumeric characters.

19. The system of claim 17, wherein said set of search results comprises said set of second-level search results that comprise said sequence of alphanumeric characters.

20. The system of claim 17, wherein said set of search results comprises said set of first-level search results corresponding to said set of second-level search results that comprise said sequence of alphanumeric characters.

21. The system of claim 20, wherein said one or more processors are operable to display said determined set of search results.

22. A non-transitory computer readable storage medium, having stored thereon, a program having at least one code section executable by a processor, thereby causing said processor to perform steps comprising:
receiving a search query from a user; and
determining a set of search results based on said received search query, wherein said set of search results comprises a set of first-level search results and a set of second-level search results associated with each search result of said set of first-level search results, wherein at least one search result from said set of second-level search is modified to comprise a portion of text of said one or more of said set of second-level search results that is different from one or more portions of text of said associated said set of first-level search results.
